(19) United States
(12) Patent Application Publication
(10) Pub. No.: US 2007/0254161 A1
(43) Pub. Date: Nov. 1, 2007

(54) HARDENING OF ORDERED FILMS OF SILICA COLLOIDS

(75) Inventors: Mary J. WIRTH, Tucson, AZ (US); Thai Van Le, Yardley, PA (US); Suping Zheng, Tucson, AZ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: THE ARIZONA BD OF REG ON BEHALF OF THE UNIV OF AZ, TUCSON, AZ (US)

(21) Appl. No.: 11/741,327

(22) Filed: Apr. 27, 2007

Related U.S. Application Data
(60) Provisional application No. 60/874,387, filed on Dec. 12, 2006.
(60) Provisional application No. 60/795,523, filed on Apr. 27, 2006.

(51) Int. Cl. B32B 17/06; B05D 1/12; B05D 3/02

(52) U.S. Cl. 428/426; 427/180; 427/372.2

(57) ABSTRACT

Sintering self-assemblies of calcined colloidal silica particles results in sintered colloidal crystals that are free of cracks that can be resolved using optical microscopy. The sintered colloidal crystals have significantly improved strength and durability, and withstand aggressive handling. Surface rehydroxylation of the sintered colloidal crystals enables subsequent chemical modification.

This application claims the priority of provisional U.S. Application No. 60/795,523, filed Apr. 27, 2006, and the priority of provisional U.S. Application No. 60/874,387, filed Dec. 12, 2006. Both 60/795,523 and 60/874,387 are incorporated by reference herein in their entireties.

This invention was made with government support under Contract Number R01 GM065980 awarded by the National Institute of Health. The government has certain rights in the invention.

This invention was made with government support under Contract Number CHE-0433779 awarded by the National Science Foundation. The government has certain rights in the invention.

### BACKGROUND OF THE INVENTION

1. Field of the Invention

The present invention relates to colloidal crystals. In particular, the present invention relates to silica colloidal crystals having improved mechanical strength and durability.

2. Discussion of the Background

Silica colloids of controlled submicron size and low polydispersity can be deposited on solid substrates to form highly ordered face-centered cubic (FCC) crystals with thicknesses ranging from two layers to several hundred layers. As a photonic device, a colloidal crystal gives strong Bragg diffraction at a wavelength determined by the colloid diameter, refractive index, and crystal thickness. There has been widespread interest in silica colloidal crystals as photonic materials for many years. New applications of silica colloidal crystals are now emerging, such as supports for lipid bilayers, patterned supports for microarrays, microreactors and media for chemical separations. These emerging applications place more demands on the quality, manufacturability, and durability of colloidal crystals.

However, silica colloidal crystals, as deposited, are very fragile. This precludes their chemical modification for many potential applications, such as media for chemical separations and substrates for microarrays having high surface areas.

Applied Physics Letters, volume 84, pages 3573-3575 (2004), discloses a method of reducing cracks in self-assembled colloidal crystals by preshrinking the colloidal particles by calcining at 300 to 600° C. prior to self-assembly. The calcining promotes the formation of siloxane bonds and drives off the ethanol and water from the colloids. However, the self-assembled colloidal crystals did not undergo further heat treatment.

Conventional silica colloidal crystals are held together by weak van-der Waals forces, and they easily come apart with even mild agitation or contact. The fragility of the crystals prevents the aggressive handling (e.g., immersion in stirred or boiling liquids) needed for chemical modification of the surfaces. Chemical modification is required for applications beyond photonics, particularly as microarrays and in chemical separations.

U.S. Pat. No. 4,131,542 discloses a process for preparing silica packing for chromatography. The process involves spray-drying an aqueous silica sol to form porous micrograms each containing closely packed colloidal silica particles, acid-washing the porous micrograms, and sintering at from 700 to 1050° C. for 30 minutes to 24 hours to effect a 5 to 20% loss in surface area and produce an increase in mechanical strength.

At the high temperatures used for sintering, flow of melted surface silica fuses the colloids together to provide the high mechanical strength needed for both chemical modification and high pressure packing of chromatographic silica gel.

However, sintering of conventional silica colloidal crystals is accompanied by shrinkage that generates cracks in the colloidal crystals.

Furthermore, sintering causes condensation of surface silanols into siloxane bonds, and the completely dehydroxylated silica surfaces are chemically unreactive to silylating agents. Rehydroxylation of silica is thus needed after sintering to convert the surface siloxanes back to silanols. The complete rehydroxylation of siloxane surfaces is an unresolved issue in the field of silica surface chemistry. Incomplete rehydroxylation of silica leaves isolated surface silanols, which degrade performance in separations, especially for biomolecules. Conditions that achieve complete rehydroxylation have not yet been reported.

### SUMMARY OF THE INVENTION

Silica colloidal crystals can be sintered with little reduction in crystalline order if the colloids are well calcined before deposition. The resulting material is durable. The material withstands extensive ultrasonication, as well as boiling, enabling it to be cleaned and chemically modified for chemical applications. The silica colloids in the sintered crystal have a refractive index approaching that of fused silica. Rehydroxylation of the surface restores surface silanols for subsequent silylation, without degrading the crystalline order. This ability to chemically modify the silica extends the range of applications for silica crystallized colloids, and includes their use as separation media and high-surface area capture material for microarrays.

### BRIEF DESCRIPTION OF THE DRAWINGS

The preferred embodiments of the invention will be described in detail, with reference to the following figures, where:

FIG. 1 illustrates a method for forming a sintered colloidal crystal;

FIG. 2 shows optical micrographs of a) sintered silica colloidal crystal with three prior calcinations steps, and b) colloidal crystal with neither calcinations nor sintering, shown to illustrate cracks; and

FIG. 3 shows field-emission SEM micrographs of a sintered silica colloidal crystal showing a) a wide field of view to show grain boundaries, and b) an expanded scale to show points of attachment among colloids.

### DETAILED DESCRIPTION OF PREFERRED EMBODIMENTS

The present invention provides sintered silica colloidal crystals that are free of cracks that can be resolved using optical microscopy. These sintered colloidal crystals have significantly improved strength and durability in comparison to conventional silica colloidal crystals.

The silica colloidal crystals of the present invention can be produced by sintering an ordered array of calcined silica particles.

As used herein, the term “ordered array” refers to a three-dimensional periodic array of particles. The particles are arranged into one of the fourteen Bravais unit cells, which are repeated in three dimensions. Preferably the ordered array has a close packed structure. Close packed structures include face-centered cubic (FCC) and hexagonal close packed (HCP) structures. Preferably the ordered array has a FCC structure.

Colloidal systems of silica particles can be produced by a variety of methods well known in the art. See, e.g., Stöber et al, Journal of Colloid and Interface Science, volume 26, pages 62-69 (1968). Preferably the colloidal silica particles are produced as monodisperse colloidal systems. The colloidal silica particles can be suspended in a sol. The liquid phase of the sol can include water or an organic liquid, e.g., an alcohol such as methanol. Colloidal silica particles can be generally spherical in shape. The colloidal silica particles contain SiO₂. Altering the composition of the colloidal particles can raise or lower the sintering temperature of the colloidal particles. For example, adding NaCO₃ to the SiO₂ can lower the sintering temperature of the particles. The colloidal silica particles can be amorphous and less dense than bulk, crystalline SiO₂.

The colloidal silica particles are calcined by heating at a temperature in a range of from 100 to 800° C., preferably 200 to 600° C., more preferably 300 to 600° C., for a period of time ranging from 1 h to 48 h, preferably 2 h to 24 h, more preferably 5 h to 15 h. Preferably the colloidal silica particles are calcined more than once. More preferably, the colloidal silica particles are calcined three times. Preferably the calcination temperature increases with each successive calcination. The calcination causes the colloidal silica particles to shrink in size.

After the calcinations, the calcined particles can be dispersed into an aqueous or organic liquid to form a slurry or sol. Preferably the liquid is an organic liquid. Preferably the organic liquid contains an alcohol, such as methanol.

The calcined particles in the slurry can be deposited on a substrate in a variety of ways. In embodiments, the calcined particles can be deposited on the substrate by spin-coating the slurry on a substrate. In other embodiments, the calcined particles can be deposited on the substrate by placing the substrate in the slurry so that a portion of the substrate remains above the slurry. As the organic liquid in the slurry evaporates, calcined colloidal silica particles at the meniscus of the slurry deposit in an ordered array on the substrate and form a colloidal crystal.

The substrate can be electrically conductive, e.g., a metal or a semiconductor, or can be electrically insulating, e.g., an insulator, over at least a portion of the substrate. In embodiments, the substrate can be a glass, fused silica, crystallized silica (quartz), sapphire, silicon, indium tin oxide or platinum. The substrate can have a flat, curved, irregular, or patterned surface, on which the calcined colloidal silica particles are deposited. The surface on which the calcined colloidal silica particles are deposited can be an outer surface of the substrate. The surface on which the calcined colloidal silica particles are deposited can also be an inner surface of a substrate, for example the inner surface of a capillary tube or the inner surface of a hole. The cross-section of the inner surface can be circular, oval, elliptical or polygonal (e.g., triangular or square). The surface of the substrate can include regions having different compositions. The substrate serves as a mold for the colloidal crystal. For example, a flat substrate can produce a colloidal crystal shaped as a flat film, and a capillary tube can produce a colloidal crystal shaped as a cylinder.

Sintering the ordered array of calcined colloidal silica particles produces a sintered colloidal crystal. The sintering causes the calcined silica particles to bond and fuse together, and thus strengthens the ordered array of calcined silica particles. The sintering is at a temperature above 800° C. and below the melting point of the colloidal particles (the melting point of SiO₂ is 1710° C.). Preferably the sintering is at a temperature in a range of from 900 to 1200° C., more preferably 1000 to 1100° C. The sintering is carried out for a period of time in a range of from 1 to 48 h, preferably 2 to 24 h, more preferably 5 to 15 h.

In embodiments, the sintered colloidal crystal contains colloidal silica particles each of which has a diameter in a range of from 50 nm to 1000 mm, preferably from 100 nm to 500 nm, more preferably from 200 nm to 400 nm. Preferably, the colloidal silica particles are all of essentially the same size.

The sintered colloidal crystal can have a thickness or diameter ranging from 50 nm to 1 mm, preferably 500 nm to 100 μm, more preferably 1 μm to 50 μm. The sintered colloidal crystal can contain 1 to 20000, preferably 10 to 1000, more preferably 50 to 100, monolayers of colloidal silica particles.

The sintering process can remove hydroxyl groups from the colloidal silica. To rehydroxylate the sintered colloidal crystal, the sintered colloidal crystal can be treated with aqueous base. For example, the sintered colloidal crystal can be rehydroxylated in a pH 9.5 tertbutylammonium hydroxide solution for 48 h at 60° C. to restore surface silanol groups removed in the sintering process.

After rehydroxylation, the sintered colloidal crystal will include one or more hydroxyl groups bonded to an exterior surface of one or more of the colloidal silica particles in the colloidal crystal.

The rehydroxylated colloidal crystal can be derivatized or coated with an additional agent, e.g., an organic material such as polyacrylamide. Organic compounds can be chemically bonded via the hydroxyl groups to the colloidal silica particles in the colloidal crystal.

The sintered colloidal crystals can be free-standing, and not attached to a substrate. Free-standing sintered colloidal crystals can be produced by removing the substrates from the colloidal crystals after sintering.

The sintered colloidal crystal is free of cracks that can be resolved using optical microscopy. Preferably, the sintered colloidal crystal is free of cracks more than 350 nm wide, more preferably more than 200 nm wide, separated by a distance of less than 0.5 mm, preferably less than 1 mm, more preferably less than 2 mm.

The absence of cracks in the sintered colloidal crystals of the present invention significantly increases the strength and durability of the colloidal crystals relative to conventional silica colloidal crystals, which are not sintered, and conventional sintered colloidal crystals, which contain cracks. Cracks degrade mechanical strength and prevent aggressive handling of colloidal crystals. The significantly improved strength and durability of the sintered colloidal crystals of the present invention permit their use in a number of applications for which conventional colloidal crystals have proved to be too fragile. For example, the improved stability of the sintered colloidal crystal of the present invention permits their use in field instrumentation.

Identification of unknown chemical species relies upon methods of separation to isolate material to be identified. Separation media have been indispensable in molecular biology for separation biological macromolecules such as proteins and nucleic acids, as well as for determining sequences of polypeptides and nucleic acids. The sintered colloidal crystals of the present invention can be used as a separation media.

For example, the sintered colloidal crystal of the present invention can be used as a separation media in processes which include passing a fluid (liquid or gas) through the sintered silica crystal. Such processes include chromatography processes, for example High Performance Liquid Chromatography (HPLC) and Thin Layer Chromatography (TLC).

The sintered colloidal crystal of the present invention can also be used in processes which include passing a fluid through the sintered silica crystal and applying an electric potential across the sintered colloidal crystal. Such processes include separation processes such as electrophoresis, electrophoretic sieving, isoelectric focusing and electrochromatography. Such processes are applicable to any charged chemical species, e.g., peptides, proteins, nucleic acids such as RNA, DNA and oligonucleotides, pharmaceuticals and ionic species that are environmentally important. The electric potential can be applied via electrodes arranged on opposite ends of the sintered colloidal crystal.

The sintered colloidal crystals of the present invention can be used to provide increased surface area for reactions or capture (particularly in microarrays for proteomics or genomics). In other words, the sintered colloidal crystal of the present invention can be used in processes in which a first chemical species is bound to the colloidal silica particles, a fluid passing through the sintered colloidal crystal contains a second chemical species, and the second species is captured on the first chemical species. For example, oligonucleotides can be used to capture other oligonucleotides, antibodies can be used to capture antigens or vice versa, lectins can be used to capture glycoproteins or vice versa, and antibodies can be used to capture various chemical species and vice versa. The sintered silica crystals of the present invention can be used as a substrate for microarrays that use chemically bound capture proteins to capture, e.g., antigens. The sintered colloidal silica crystals of the present invention can be functionalized with other chemical species, such as silylating agents, polyacrylamide, other polymers, DNA, antibodies, and proteins.

The sintered colloidal crystal of the present invention can be used in processes in which living cells are grown on the sintered colloidal crystal. The porosity of the sintered colloidal crystals allows chemical species, such as water, nutrients and drugs, to reach the cell surfaces. The sintered colloidal crystal of the present invention can also be used in processes in which a lipid bilayer or cell membrane is attached to the sintered colloidal crystal.

The sintered colloidal crystals of the present invention can also be used as microporous coatings on microscope slides and coverslips. Cells grown on such microporous coatings can be interrogated by microscopic techniques, such as Total Internal Reflection Fluorescence Microscopy (TIRFM), in which light is passed through the sintered colloidal crystal.

The sintered colloidal crystal of the present invention can be used in processes in which an organic material is introduced into the sintered colloidal crystal and the organic material is then vaporized and ionized. Such processes include Matrix-assisted laser desorption/ionization (MALDI) mass spectrometry.

The invention having been generally described, reference is now made to examples, which are provided herein for purposes of illustration only, and are not intended to be limiting unless otherwise specified.

### EXAMPLES

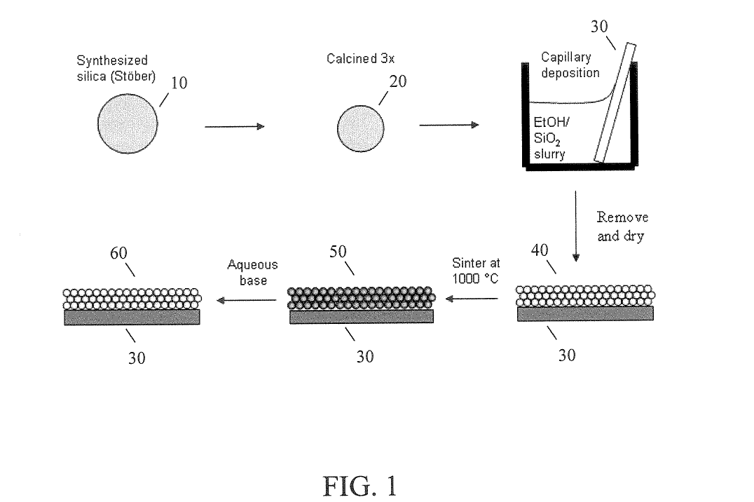

A process for producing the sintered colloidal silica crystal of the present invention is illustrated in FIG. 1.

The Stöber method (Journal of Colloid and Interface Science, volume 26, pages 62-69 (1968)) was used to synthesize colloidal silica particles 10. A 500 ml round bottom flask and a 250 ml beaker were cleaned by immersion in a saturated KOH/isopropanol solution for 24 hr, followed by an extensive water (deionized, 18 MΩ cm) rinse, then with ethanol and dried at 120° C. in an oven for 2 h. Solution A was made with 50 ml 2 M ammonium hydroxide, 20 ml deionized H₂O, and 23 ml ethanol filtered with a Nalgene syringe filter (polytetrafluoroethylene, 25 mm diameter, 0.2 μm) into 500 ml round bottom flask. Solution A was spun by a magnetic stirring bar at a slow and constant rate. Solution B was made by putting 100 ml ethanol and 7.2 ml tetraethoxysilane filtered by Nalgene syringe filter into the 250 ml beaker. Solution B was put in an ultrasonicated bath (VWR, model 75T) for 2 min. Solution B was added to solution A at a rapid pace. The reaction was run at room temperature for 3 h with constant stirring. The resulting colloidal silica particles 10 were then rinsed by centrifugation at 10,000 rpm for 15 min. The supernatant was removed and the colloidal pellet was rinsed and re-suspended in pure ethanol by sonication. This procedure was performed three times.

Colloidal silica particles 10 were calcinated in a Pyrex beaker covered with a Coors ceramic crucible. The colloidal silica particles 10 were heated to 300, 450 and 550° C., in succession, for 12 h at each temperature. After each calcination step, the colloids were dispersed in ethanol using the ultrasonication bath for 4 h. This was done to minimize the number of aggregates. The three calcination steps were found to avoid the formation of cracks in the later step of sintering. After calcination was complete, the calcined colloidal silica particles 20 were re-suspended in ethanol using the ultrasonication bath, and the suspension was allowed to rest at ambient temperature for 24 h to allow aggregates to settle.

Silica colloidal crystals 40 were formed on fused silica slides 30 that were cleaned by dipping into boiling methanol followed by placement in a UV-ozone plasma cleaner (Novascan Technologies, PSD-UV) at 20 W/cm² for 10 min. Then the fused silica slides 30 were placed vertically into 30 mL glass beakers containing approximately 20 mL of a colloidal suspension. The colloidal suspension was prepared by sonication of calcined colloidal silica particles 20 in ethanol for 2 hours. (0.1 g colloid in 20 mL ethanol). The suspension was incubated under a 100-W incandescent lamp for 20 h to accelerate the evaporation of ethanol relative to lab ambient conditions. For Fourier Transform Infrared (FTIR) analysis, the same procedure was used, but with polished silicon wafers as substrates.

The fused silica slides 30 bearing the silica colloidal crystals 40 were sintered atop a 0.25 inch quartz plate (not shown) in a furnace at 1050° C. for 12 h. The quartz plate was used to prevent the fused silica slides 30 from warping during lengthy sintering. The sintered crystal 50 was then allowed to cool gradually over a period of 3-4 hours within the furnace. The oven door remained closed during cooling to avoid sudden, large changes in temperature which might cause cracks in the material. To produce rehydroxylated crystals 60, the sintered crystal 50 was placed in a solution of tetrabutylammonium hydroxide of pH 9.5 at 60° C. for 24 h, followed by a rinsing procedure which consisted of deionized H₂O, 1 M nitric acid, methanol, then deionized H₂O, in succession.

To demonstrate that the surface was chemically reactive, a brush layer of polyacrylamide with nominal thickness of 10 nm was grown by atom-transfer radical polymerization. Prior to chemically modification, the sintered material was cleaned in hot methanol for 2 h, rinsed with deionized water, and dried under nitrogen in a tube furnace at room temperature. The clean sintered material was placed in a 250 mL flask that contained 1.0 mL of (chloromethylphenylethyl)dimethylchlorosilane (Gelest, Morrisville, Pa.) and 1.0 ml of pyridine in 100 mL of dicholoromethane. The reaction proceeded at reflux-temperature overnight. After the reaction, the silica gel was rinsed with dichloromethane, toluene, and methanol then dried in an oven at 110° C. for 1.0 h. The colloidal crystal was modified with polyacrylamide by free radical polymerization with a CuCl/CuCl₂/Me₆TREN catalytic system at room temperature. A Schlenk flask was charged with 49.5 mg (500 μmol) of CuCl and 6.7 mg (50 μmol) of CuCl₂. The flask was sealed with a rubber stopper and cycled between vacuum and argon three times to remove oxygen. A 100 mL solution of 3 M acrylamide in N,N-dimethylformamide was bubbled with argon for 2 h and then transferred into the flask via a syringe. After the catalyst has completely dissolved, 0.17 mL (120 μmol) of Me₆TREN was injected into the flask. The reaction solution was then transferred to another flask containing silica material, which was sealed with a rubber stopper and cycled between vacuum and argon at least three times to remove oxygen. Then the flask was placed in a water bath at room temperature and allowed to react for 10 h. After reaction, the material was rinsed with N,N-dimethylformamide.

FTIR spectra were obtained for colloidal crystals on silicon using 256 scans, and a blank silicon slide was used as the reference. The spectra were taken at 55° incidence using a Nicolet 4700 FTIR from Thermo Electron Corporation. UV-visible absorbance spectra were obtained at normal incidence using a blank silica slide as the reference, using an Agilent 8453 spectrophotometer. Optical micrographs were obtained using a Nikon Eclipse TE2000-U microscope with a Nikon model C-SHG1 mercury lamp power supply, and a Cascade 512B CCD camera from Photometrics. Scanning Electron Microscope (SEM) images were obtained using a field-emission Hitachi S-4500 using Thermo-Norm Digital Imaging/EDS.

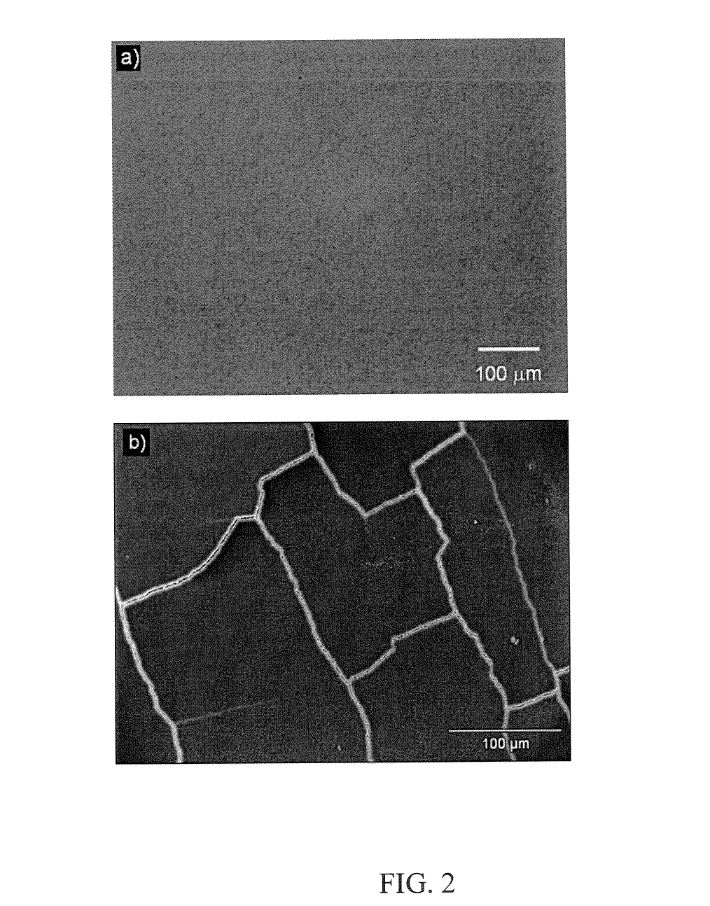

FIG. 2a shows an optical micrograph for a sintered colloidal crystal. To demonstrate that cracks would be evident on this scale, FIG. 2b shows the optical micrograph for a colloidal crystal made from the same colloids but without any calcination. This latter crystal was not sintered, therefore, the cracks were caused by shrinkage at room temperature after storing these materials dry. The triply calcined materials, even after sintering, show no cracks that were able to be resolved by the optical microscopy.

The underlying processes that occur upon calcination and sintering were monitored by FTIR measurements. The peaks for the reagents disappear with progressive heat treatment. Specifically, the broad peak in the O—H stretching region, maximizing near 3400 cm⁻¹, which corresponds to reagent water, and the C—H stretches from 2800 to 2900 cm⁻¹, which correspond to the ethoxy groups of TEOS, disappear. The TEOS peak is small, and it disappears after calcination. The silanols also drop progressively with heat treatment. Specifically, the peaks for the hydrogen bonded silanols (3600 cm⁻¹) and the isolated silanols (3745 cm⁻¹) both drop with calcinations and drop further with sintering. The siloxane peaks resulting from condensation of the silanols are at 1868 to 1990 cm⁻¹, and these are shown to increase markedly upon calcination and then further upon sintering. The sintered material has lost almost all water and silanols, and its spectrum is dominated by the siloxane peaks, indicating that it has approached the composition of fused silica.

A sensitive test to detect structural changes in the colloidal crystal is the photonic bandgap, which is a sharp band in the absorption spectra due to attenuation at the wavelength for Bragg diffraction. The lattice spacing, d₁₁₁, which is in the surface plane, is 86% of the particle diameter for fcc crystals. The lattice spacing is related to the peak wavelength for Bragg diffraction, λₚₑₐₖ.

m·λₚₑₐₖ=2·d₁₁₁(n²_{neff}−sin²θ)^{1/2} (1)

### In Eq. 1, m is the order of diffraction, which is 1 in this case, 0 is the angle between the incident light and the normal to the diffraction planes, which is 0° in this case, and n_{eff} is the mean refractive index of the crystalline lattice.

n²_{eff}=0.74·n²_{silca}=0.26·n²ₐᵢᵣ (2)

A comparison was made of the visible transmission spectra for a colloidal crystal using colloids as-made (no calcinations), a colloidal crystal using colloids from the same batch and calcinated three time but not sintered, and a colloidal crystal made with calcinated colloids and then sintered. The Bragg peak was evident in each spectrum, indicating crystalline order. The Bragg peak shifted 29-nm to the blue upon calcination, and it shifted another 11 nm further to the blue upon sintering, indicating progressive shrinkage of the particles with heat treatment. This is consistent with the FTIR spectra, which show progressive loss of water with calcination and sintering. For the calcined material, sintering reduced the height of the Bragg peak, indicating a small decrease in crystallinity.

The sizes of the colloids, as determined by SEM, at each step in the heating process are listed in Table 1.

TABLE 1

| | Refractive index | Colloid | | Predicted | | Observed Bragg | |
|---|---|---|---|---|---|---|---|
| Material | (λ = 589 nm) | diameter | | Bragg peak | | peak | |
| as-made | 1.44–1.46 | 205–215 | nm | 448–473 | nm | 454 | nm (broad) |
| calcined | 1.439 | 193 | nm | 422 | nm | 425 | nm |
| sintered | 1.457 | 188 | nm | 415 | nm | 414 | nm |

| | | | | | |
|---|---|---|---|---|---|
| rehydroxylated | 1.457 | — | — | 409 | nm |

Table 1 shows that there is a greater decrease in diameter going from as-made to calcined than there is going from calcined to sintered. The calculated change in colloid volume is approximately three times higher upon calcination than it is upon sintering, which is in agreement with the relative changes in the intensities of the water peaks in the infrared spectra.

A decreased colloid size is expected to be associated with an increase in colloid density, and therefore an increase in refractive index. Data obtained using index-matching liquids bear out part of this expectation. The as-made colloids exhibit a distribution of refractive indices, indicating that the material is heterogeneous on the optical scale. The calcined colloids have a lower and better defined refractive index, 1.439, compared to the as-made colloid. The decrease in refractive index suggests that while the calcination removes water, at least part of the volume is filled by air rather than by silica. Upon sintering, the refractive index increases to a value of 1.457, which approaches the refractive index of fused silica, 1.458. These results show that the conversion to the higher index colloid is achieved. Having essentially solid colloids is beneficial to applications of these materials.

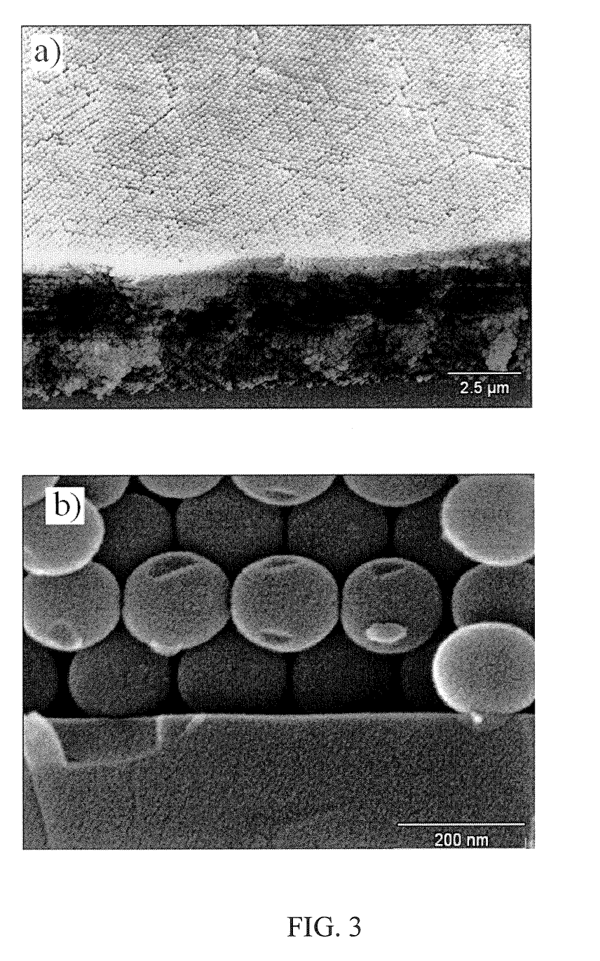

Once the amount of particle shrinkage has been determined, the cracking behavior can be re-examined. Certainly greater shrinkage would be expected to give larger cracks, but this does not readily explain the absence of visible cracks in optical micrograph of the material made of calcined colloids. Insight can be gained from a higher resolution using SEM imaging of the sintered material, which is shown in FIG. 3a. Slight gaps are now evident, and they occur at grain boundaries, which are frequent: about once every 10 colloids or so. These frequent cracks perhaps accommodate the shrinkage of calcined particles upon sintering to give cumulative gaps that are less than the wavelength of light. This would explain why the cracks are not visible in an optical micrograph. Additional calcination before preparing colloidal crystals would likely preserve more crystalline order upon sintering, as the infrared spectra show that the composition of the colloids has not been completely converted to pure silica. Both the SEM image of FIG. 3a and the Bragg diffraction peaks discussed above establish that the material retains crystallinity despite the nanoscale gaps at the domain boundaries. The SEM image shows that gaps do not connect together to allow the material to come apart easily. FIG. 3b shows an SEM image on a high magnification scale to show the details of individual colloids. The colloids now exhibit blebs and divots, which result from the attachments among colloids upon sintering. The many attachment points among colloids explain why the material is now durable.

The integrity of the crystalline lattices before and after ultrasonication in ethanol can be evaluated more critically with UV-visible transmission spectroscopy. Visually, the unsintered crystals ruptured apart after 2 minutes of ultrasonication, whereas the sintered crystal appeared unaffected even after 3 hours of ultrasonication. Ultrasonication longer than 3 hour was not investigated. The sintered material exhibited a Bragg diffraction peak in the UV-visible spectrum that remained unchanged before and after ultrasonication. This strongly suggests that the material is sufficiently robust to withstand the procedures required for chemical modification, which include boiling, rinsing and extended reactions procedures in various solvents at elevated temperatures. Sintered ordered arrays of calcined colloidal silica particles exhibited sharper, better defined, Bragg peaks than sintered ordered arrays of colloidal silica particles that were not calcined before sintering.

Optimal modification of silica via reactive silanes requires complete rehydroxylation of surface siloxanes to surface silanols to avoid the generation of isolated silanols. This process requires a relatively aggressive chemical treatment involving extended storage in a mild base at elevated temperatures. To demonstrate that the sintered silica crystal colloids can be suitably modified in such a manner, the steps for rehydroxylation of the sintered colloidal crystal were performed to convert surface siloxanes into surface silanols. Upon rehydroxylation, infrared spectra confirm a large gain in the peak area for hydrogen-bonded silanols, centered at 3600 cm⁻¹. The amount of water adsorbed to this newly hydrophilic surface also increased, as shown by a broad band centered at 3300 cm⁻¹. The peak for the isolated silanols was virtually undetectable, and it was lower than that for chromatographic silica gel, indicating that the surface was now fully rehydroxylated. The infrared spectra thus established that the surface silanols were regenerated, and these surface silanols are presumably available for reaction with chlorosilanes, allowing chemical modification for end-applications. To demonstrate that these can be chemically modified without losing the integrity of the crystal, a polyacrylamide brush layer was grown by atom-transfer radical polymerization. The resulting infrared spectrum showed new bands in the C—H stretch region near 2900 cm⁻¹, which arise from the polymer backbone, as well as a peak from the N—H stretch at 3200 cm⁻¹. The spectrum showed that there was water solvating these hydrophilic polymer chains.

The Bragg peak of a colloidal crystal during the rehydroxylation and chemical modification procedures was monitored. Again, the lattice spacing shrinks slightly upon sintering, and the size of the Bragg peak again becomes smaller. Upon rehydroxylation, the Bragg peak shifts 5 nm further to the blue, presumably due to removal of silica from the spheres. The theoretical transmission spectrum has been derived using the scalar wave approximation of Journal of Chemical Physics, volume 111, pages 345-354 (1999), and using this expression reveals that the 5 nm shift corresponds to the volume fraction of silica dropping from 0.74 for an fcc lattice to 0.72 upon removal of silica from the spheres. This corresponds to etching 5 nm of silica from the surface. The theory does not predict the observed increase in the height of the Bragg peak. The data further shows that the growth of the polymer shifts the Bragg peak back to where it was before rehydroxylation, consistent with adding a 5 nm polyacrylamide film, which has a refractive index similar to that of silica. The chemical modification steps required numerous cleaning and rinsing steps, as well as heating, and the spectra demonstrate that the colloidal crystal remained intact.

The disclosure herein of a numerical range is intended to be the disclosure of the endpoints of that numerical range and of every integer within that numerical range.

While the present invention has been described with respect to specific embodiments, it is not confined to the specific details set forth, but includes various changes and modifications that may suggest themselves to those skilled in the art, all falling within the scope of the invention as defined by the following claims.

What is claimed is:

1. A sintered colloidal crystal comprising an ordered array of colloidal silica particles, wherein
the sintered colloidal crystal is free of cracks that can be resolved using optical microscopy.

2. The sintered colloidal crystal according to claim 1, wherein the sintered colloidal crystal is free of cracks more than 350 nm wide separated by less than 0.5 mm.

3. The sintered colloidal crystal according to claim 1, wherein each of the colloidal silica particles has a diameter in a range of from 50 to 1000 nm.

4. The sintered colloidal crystal according to claim 1, wherein the sintered colloidal crystal is produced by a process comprising
calcining colloidal silica particles at 100 to 800° C.;
depositing the calcined colloidal silica particles on a substrate in an ordered array; and
sintering the ordered array of calcined colloidal silica particles above 800° C.

5. The sintered colloidal crystal according to claim 1, wherein the sintered colloidal crystal is on a substrate.

6. The sintered colloidal crystal according to claim 5, wherein at least a portion of the substrate is electrically conductive.

7. The sintered colloidal crystal according to claim 1, wherein the ordered array has a close packed structure.

8. The sintered colloidal crystal according to claim 1, further comprising at least one hydroxyl group bonded to an exterior surface of at least one of the colloidal silica particles.

9. The sintered colloidal crystal according to claim 1, further comprising at least one organic compound chemically bonded to at least one of the colloidal silica particles.

10. A method of making a colloidal crystal, the method comprising
calcining colloidal silica particles at 100 to 800° C.;
depositing the calcined colloidal silica particles on a substrate in an ordered array;
sintering the ordered array of calcined colloidal silica particles above 800° C.; and
producing the sintered colloidal crystal of claim 1.

11. The method according to claim 10, wherein the depositing comprises spin-coating the calcined colloidal silica particles on the substrate.

12. A method of using a colloidal crystal, the method comprising a process that includes passing a fluid through the sintered colloidal crystal of claim 1.

13. The method according to claim 12, wherein the process further includes applying an electric potential across the sintered colloidal crystal.

14. The method according to claim 13, wherein the process is an electrophoretic process.

15. The method according to claim 12, wherein
the sintered colloidal crystal comprises a first chemical species bound to the colloidal silica particles;
the fluid contains a second chemical species; and
the process further includes capturing the second chemical species on the first chemical species.

16. The method according to claim 12, wherein the process further includes growing living cells on the sintered colloidal crystal of claim 1.

17. A method of using a colloidal crystal, the method comprising attaching a lipid bilayer to the sintered colloidal crystal of claim 1.

18. A method of using a colloidal crystal, the method comprising attaching a cell membrane to the sintered colloidal crystal of claim 1.

19. A method of using a colloidal crystal, the method comprising passing light through the sintered colloidal crystal of claim 1.

20. A method of using a colloidal crystal, the method comprising
introducing an organic material into the sintered colloidal crystal of claim 1; and
vaporizing and ionizing at least a portion of the organic material.
